(19) United States
(12) Patent Application Publication
(10) Pub. No.: US 2026/0136179 A1
(43) Pub. Date: May 14, 2026

(54) SYSTEMS AND METHODS FOR MULTI-FACTOR NETWORK-ASSISTED REAL-TIME AUTHENTICATION of USER EQUIPMENT IN A WIRELESS NETWORK

(71) Applicant: Verizon Patent and Licensing Inc., Basking Ridge, NJ (US)

(72) Inventors: Manuel Enrique Caceres, Basking Ridge, NJ (US); Stephen C. Schwed, Bernardsville, NJ (US)

(73) Assignee: Verizon Patent and Licensing Inc., Basking Ridge, NJ (US)

(21) Appl. No.: 18/946,383

(22) Filed: Nov. 13, 2024

(51) Int. Cl. H04W 12/06

(52) U.S. Cl. CPC H04W 12/06

(57) ABSTRACT

A device described herein may wirelessly communicate with a security device; maintain information indicating that the device has wirelessly communicated with the security device; receive network-based authentication information associated with the device, wherein the network-based authentication information includes one or more digital signatures generated by a particular wireless network; generate a security score for the device based on the information indicating that the device has wirelessly communicated with the security device, and the network-based authentication information associated with the device; and output, to a particular network-accessible resource, an access request, wherein outputting the access request includes outputting the security score and the one or more digital signatures generated by the particular wireless network, wherein the network-accessible resource accepts or denies the access request based on the security score and the one or more digital signatures generated by the particular wireless network.

### BACKGROUND

Wireless networks provide wireless connectivity to User Equipment (“UEs”), such as mobile telephones, tablets, Internet of Things (“IoT”) devices, Machine-to-Machine (“M2M”) devices, or the like. Wireless networks have the capability to implement mechanisms such as determining the location of UEs, authenticating security credentials of UEs (e.g., as maintained on a Subscriber Identification Module “SIM” cards or an embedded SIM (“eSIM”)), authenticating UE identifiers such as Mobile Directory Number (“MDN”), International Mobile Station Equipment Identity (“IMEI”), etc. Additionally, UEs may be able to wirelessly communicate with security devices such as Near Field Communication (“NFC”)-enabled “chip cards.” One example of a chip card is a card that includes a Europay, Mastercard, Visa (“EMV”) chip, which may implement security and/or authentication mechanisms, such as a procedure in which tapping a particular EMV chip to a suitable EMV reader indicates the presence of the particular, unique EMV chip at the time of the tap.

### BRIEF DESCRIPTION OF THE DRAWINGS

FIGS. 1 and 2 illustrate an example registration of one or more security cards with a UE, in accordance with some embodiments;

FIG. 3 illustrates the establishment of a security token associated with a security card, in accordance with some embodiments;

FIG. 4 illustrates an example of security policies that are applicable to a given UE, in accordance with some embodiments;

FIG. 5 illustrates an example of performing multi-factor authentication based on a security policy, in accordance with some embodiments;

FIGS. 6 and 7 illustrate an example of generating and providing a real-time UE security score, in accordance with some embodiments;

FIG. 8 illustrates an example of modifying a UE security score over time, in accordance with some embodiments;

FIG. 9 illustrates an example of distributing UE security information via a blockchain, in accordance with some embodiments;

FIG. 10 illustrates an example process for maintaining and using a real-time security score for a UE, in accordance with some embodiments;

FIGS. 11A and 11B illustrate example operations associated with recording information to a blockchain, in accordance with some embodiments;

FIGS. 12 and 13 illustrate example environments in which one or more embodiments, described herein, may be implemented;

FIG. 14 illustrates an example arrangement of a radio access network (“RAN”), in accordance with some embodiments; and

FIG. 15 illustrates example components of one or more devices, in accordance with one or more embodiments described herein.

### DETAILED DESCRIPTION OF EXAMPLE EMBODIMENTS

The following detailed description refers to the accompanying drawings. The same reference numbers in different drawings may identify the same or similar elements.

Embodiments described herein may provide for an ongoing, real-time multi-factor authentication of a device, such as a UE. As discussed herein, the multiple factors may include network-based authentication mechanism such as SIM-based authentication. As another example, the factors may include secure network-provided information such as location information. As yet another example, the factors may include biometric-based authentication mechanisms such as face, voice, or fingerprint recognition.

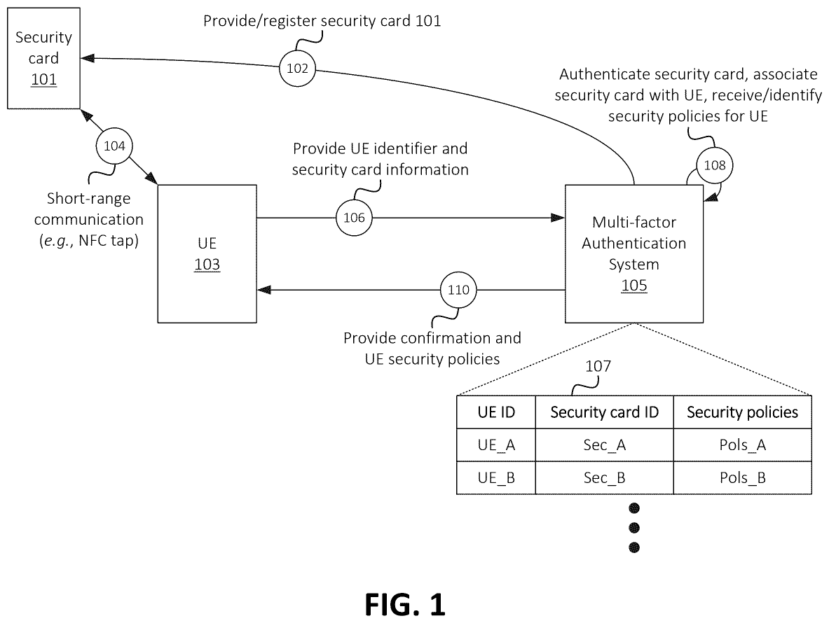

In some embodiments, the factors may include authentication mechanisms involving a UE and one or more other types of devices, such as a secure element (e.g., an EMV chip or other type of chip), a short-rage wireless device such as an NFC device, and/or some other type of device. In examples described herein, and as shown in FIG. 1, some embodiments may include authentication mechanisms in which a device with wireless communication capabilities (e.g., security card 101) may communicate with UE 103. For example, such communications may include communications via a short-range wireless communication protocol such as NFC, Bluetooth®, or the like. In examples described herein, the communications may include a “tap” of security card 101 and UE 103 (e.g., physical contact of security card 101 and UE 103, or security card 101 and UE 103 otherwise being within communications range of each other). In other examples, other types of communications between security card 101 and UE 103 may be implemented in accordance with embodiments described herein.

Security card 101 may include a secure element (e.g., an EMV chip or other types of hardware circuitry) that is able to implement or participate in authentication mechanisms. For example, security card 101 may include an EMV chip that is capable of computing or processing values, generating or storing authentication keys, performing encryption and/or decrypting operations, or performing other processing operations in the course of implementing one or more authentication mechanisms. Access to the secure element may be protected by encryption or other security mechanisms, such that the operations performed by the secure element or the values used in performing such operations may not be modified or tampered with, in the absence of the ability to satisfy the security mechanisms implemented by the secure element. Security card 101 may include wireless circuitry, such as one or more radios, transceivers, or the like. Security card 101 may communicate with one or more other devices, such as UE 103, such as providing input and/or output associated with the secure element (e.g., EMV chip or other type of secure chip or device), via the wireless circuitry.

As shown, security card 101 may be provided by and/or registered with (at 102) Multi-factor Authentication System (“MFAS”) 105. MFAS 105 may, for example, issue, manufacture, or otherwise provide security card 101 (e.g., to a user of UE 103). Additionally, or alternatively, MFAS 105 may otherwise register or identify security card 101 (along with multiple other security cards 101). Each security card 101 may be associated with a unique identifier, a unique set of public keys, one or more values maintained by EMV chips of security cards 101, etc. MFAS 105 may accordingly maintain identifying information for each security card 101. Additionally, each security card 101 (e.g., an EMV chip of each security card 101) may maintain its own unique identifier.

In some embodiments, registering security card 101 may include generating, exchanging, or providing one or more keys, such as symmetric keys, asymmetric keys (e.g., a public-private key pair), or the like. Additionally, or alternatively, registering security card 101 may otherwise include configuring or initializing one or more authentication mechanisms that may be used by MFAS 105 to authenticate security card 101.

Registering a particular security card 101 may include, in some embodiments, associating security card 101 with a particular UE 103. For example, UE 103 may communicate (at 104) with security card 101, such as via a short-range communication which may include a tap using an NFC wireless protocol. In some embodiments, UE 103 may implement an API, an application, etc. that is configured to communicate with security card 101. For example, UE 103 may receive information generated or provided by an EMV chip of security card 101, which may include the unique identifier of security card 101 and/or of the EMV chip.

In some embodiments, UE 103 and/or some other suitable device or system may provide (at 106) an identifier of UE 103 (e.g., a Mobile Directory Number (“MDN”) or some other suitable identifier) and of security card 101 to MFAS 105. For example, UE 103 may communicate with MFAS 105 via an application or “app” executing on UE 103, via an API implemented by UE 103 and MFAS 105, via a web portal associated with MFAS 105, etc. In some embodiments, a wireless network to which UE 103 is registered (e.g., a “home” network of UE 103) may provide an authentication token, a cryptographic signature, etc. indicating that the identifier of UE 103 has been verified by the wireless network. In some embodiments, UE 103 and/or some other suitable entity may provide an indication that security card 101 is associated with UE 103. For example, a user of UE 103 may tap (at 104) security card 101 to UE 103, and/or otherwise may provide an identifier of UE 103 (e.g., an MDN of UE 103) and of security card 101 (e.g., a unique identifier of security card 101 which may be physically printed on security card 101 or otherwise provided to the user) to MFAS 105.

MFAS 105 may authenticate (at 108) security card 101, and may associate security card 101 with UE 103. For example, as discussed above, security card 101 and MFAS 105 may implement one or more authentication mechanisms, in which MFAS 105 is able to authenticate security card 101. Security card 101 may, as noted above, provide (e.g., at 104) encrypted information, one or more keys, tokens, cryptographic signatures, or the like, which may be used by MFAS 105 to authenticate security card 101. The providing (at 106) of the security card information by UE 103 may indicate that a user of UE 103 has simultaneous possession of both security card 101 and UE 103, thus establishing a verifiable association of security card 101 and UE 103.

MFAS 105 may, in some embodiments, maintain example data structure 107, associating respective security cards 101 with respective UEs 103. For example, an identifier of a first UE 103 is represented as “UE_A” and an identifier of a first security card 101 is represented as “Sec_A.” Similarly, an identifier of a second UE 103 is represented as “UE_B” and an identifier of a second security card 101 is represented as “Sec_B.”

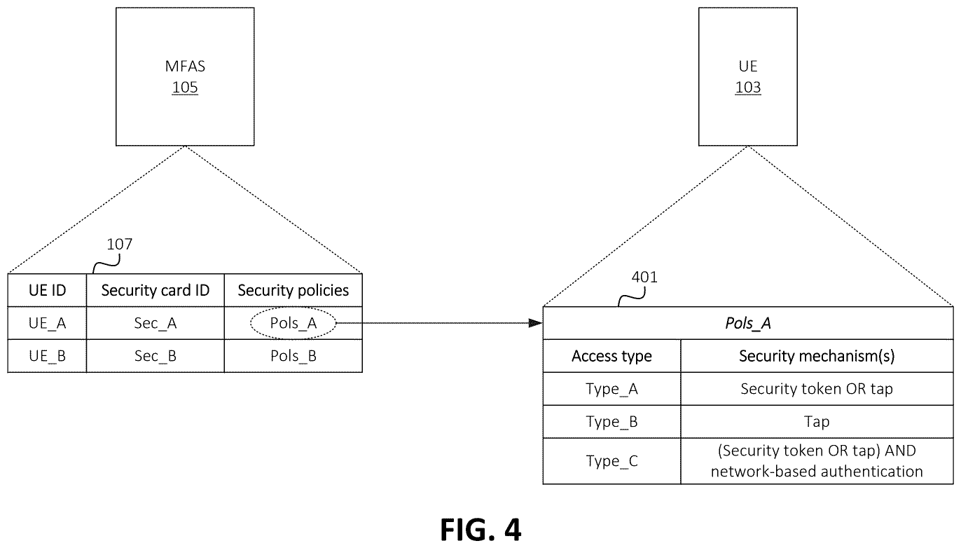

MFAS 105 may additionally receive or maintain (e.g., in data structure 107) one or more security policies associated with each security card 101 and/or UE 103. For example, a first set of security policies (represented as “Pols_A”) may be associated with the first security card 101 and the first UE 103, and a second set of security policies (represented as “Pols_B”) may be associated with the second security card 101 and the second UE 103. In some instances, the same UE 103 may be associated with different security policies for different security cards 101. For example, the same UE 103 may be registered with multiple security cards 101, and the multiple security card 101 may each be associated with different security policies. As discussed below (e.g., with respect to FIG. 4), different security policies may indicate different types or mechanisms of authentication that are required for different types of access.

MFAS 105 may provide (at 110) a confirmation of the registration of security card 101 with UE 103. In some embodiments, MFAS 105 may further provide (at 110) one or more security policies to UE 103, where such security policies are applicable to UE 103 as well as to one or more security cards 101 registered with UE 103. UE 103 may implement such security policies when receiving access requests, such as requests initiated by a user of UE 103 or by an application executing at UE 103.

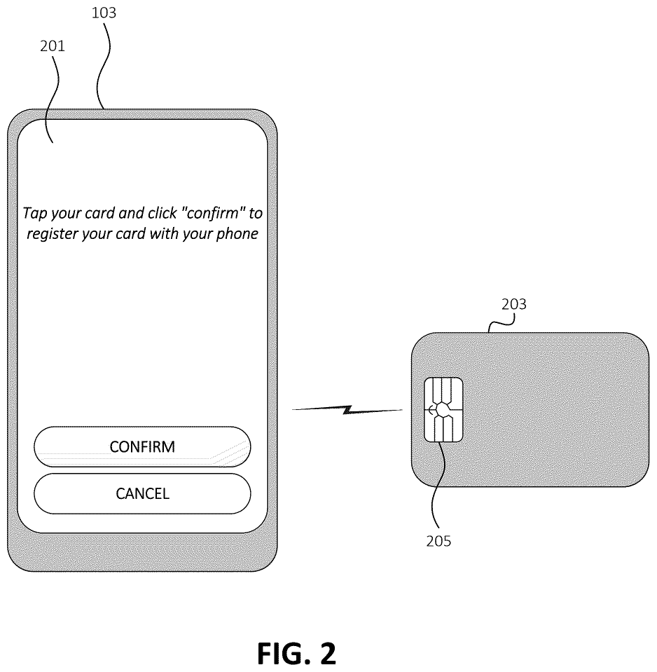

FIG. 2 illustrates an example of registering security card 101 with a particular UE 103. For example, as shown, UE 103 may present user interface 201, which may include one or more options or instructions to register a particular user interface 201 (e.g., example security card 203 which includes EMV chip 205) with UE 103. User interface 201 may indicate, for example, that a given security card 101 should be tapped to UE 103. In some embodiments, EMV chip 205 may indicate a particular MFAS 105 with which EMV chip 205 and/or security card 203 are associated (e.g., where different MFASs 105 may issue different sets of security cards 101). In some embodiments, EMV chip 205 may provide one or more keys, authentication tokens, signatures, or the like, which may be forwarded (e.g., at 106) to MFAS 105, such that MFAS 105 may authenticate EMV chip 205 and/or security card 203.

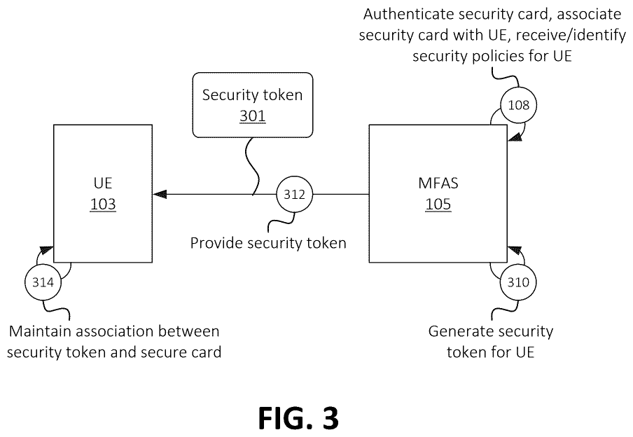

As shown in FIG. 3, when authenticating (e.g., at 108) security card 101 and/or associating security card 101 with UE 103, MFAS 105 may generate (at 310) a security token, indicating the association of security card 101 with UE 103. The security token may, for example, include one or more keys, encrypted values, or the like. MFAS 105 may provide (at 312) security token 301 to UE 103. UE 103 may maintain (at 314) an association between security token 301 and security card 101. As discussed below, security token 301 may be usable in some situations as a substitute or proxy for tapping security card 101 to UE 103.

For example, as shown in FIG. 4, one or more security policies may indicate that security token 301 is usable for one or more different access types. As noted above, MFAS 105 may maintain data structure 107, associating a particular UE 103 and/or a particular security card 101 with one or more security policies. As further noted above, MFAS 105 may provide (e.g., at 110) an indication of such security policies to UE 103. Example data structure 401 may be maintained by UE 103 (e.g., by a SIM of UE 103 and/or by some other portion or component of UE 103). Data structure 401 includes different security mechanisms that are required for different access types (e.g., represented as “Type_A,” “Type_B,” “Type_C”, and so on). Different “access types” may refer to, for example, different applications (or “apps”) via which a request or other type of message is sent, different Uniform Resource Locators (“URLs”) or Internet Protocol (“IP”) addresses to which a request or other type of message is sent, an identifier of a particular application server or entity to which a request or other type of message is sent, a particular location of UE 103 when UE 103 outputs a request or other type of message, a particular time at which UE 103 outputs a request or other type of message, or other conditions, parameters, conditions, etc. associated with a given access or access request.

As one example, UE 103 outputting a first request to a first application server may constitute a first access type, and UE 103 outputting a second request to a second application server may constitute a second access type. As another example, UE 103 outputting a first request to a particular application server, while UE 103 is located in a first location, may constitute a first access type, while UE 103 outputting a second request to the same particular application server, while UE 103 is located in a second location, may constitute a second access type.

As shown, the particular set of policies associated with UE 103 and/or a given security card 101 may include different security mechanisms to be implemented (e.g., which are required for access) for different access types. For example, “Type_A” access requests may employ either a security token (e.g., security token 301 that is associated with a particular security card 101) or a tap of security card 101. An API, application, etc. executing on UE 103 may, for example, present a user interface that indicates that a user of UE 103 may select to use a previously issued security token 301, or may elect to tap security card 101 in conjunction with an access request. As another example, UE 103 may utilize security token 301 if available, and may request a tap of security card 101 in instances where security token 301 is not available.

As another example, the security policies may indicate that for “Type_B” access requests, a tap of security card 101 is required. For example, even in instances where UE 103 maintains security token 301 which is associated with security card 101, a tap of security card 101 may still be required for such access requests. In some embodiments, the security policies may include one or more authentication mechanisms in addition to, or in lieu of, authentication mechanisms that are based on security card 101 and/or security token 301. For example, “Type_C” requests may employee one or more network-based authentication techniques, such as providing a signature or other type of information from a SIM of UE 103, providing a callback URL or other type of communication mechanism whereby a wireless network with which UE 103 is registered may provide a token or signature, a network-provided location of UE 103, or other suitable network-based authentication mechanisms. In this manner, combining different authentication mechanisms (e.g., authentication mechanisms based on security card 101 and/or security token 301 as well as network-based authentication mechanisms) may serve to enhance the security of a user of security card 101 and/or UE 103. For example, such combinations of mechanisms may be used to verify that both UE 103 and security card 101 are present and/or are authenticated at the time of a given access request.

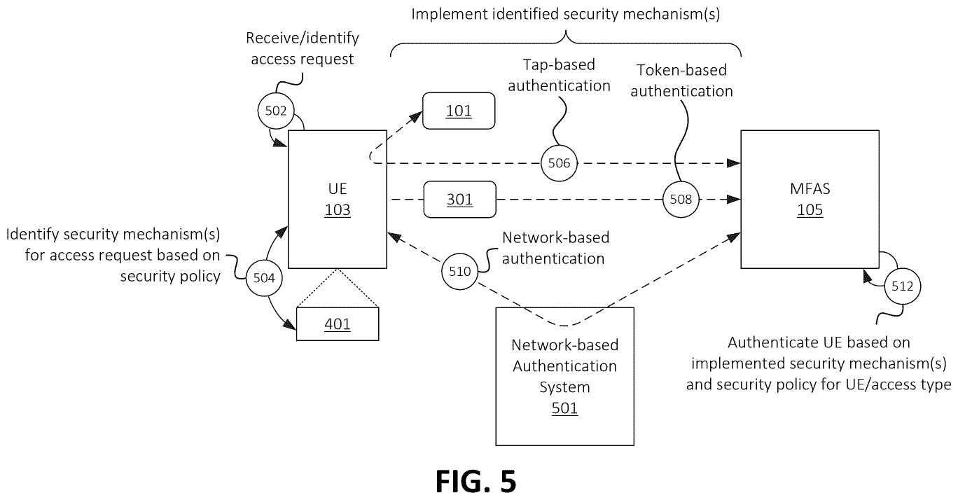

As shown in FIG. 5, for example, UE 103 may receive or identify (at 502) a particular access request, such as a request made by a user via an application executing at UE 103. As discussed above, UE 103 may identify (at 504) one or more security mechanisms to implement for the access request, such as based on information maintained in data structure 401. UE 103 may accordingly implement the identified security mechanism(s). For example, in some situations, UE 103 may initiate or participate in (at 506) a tap-based authentication, in which security card 101 is tapped to UE 103. The tap may include one or more communications between security card 101 and UE 103, such as security card 101 providing one or more keys, tokens, encrypted valued, etc. to UE 103, and UE 103 forwarding such information to MFAS 105.

Additionally, or alternatively, UE 103 may provide (at 508) one or more security tokens 301 to MFAS 105, such as a particular security token 301 that has been generated based on a previous tap of security card 101 to UE 103. Additionally, or alternatively, UE 103 may initiate or participate in (at 510) a network-based authentication or verification. For example, UE 103 may communicate with MFAS 105 and/or Network-based Authentication System (“NBAS”) 501, such that MFAS 105 may receive one or more signatures, tokens, etc. from NBAS 501 indicating that UE 103 has been successfully authenticated or verified by NBAS 501. In some embodiments, NBAS 501 may provide additional information associated with UE 103 to MFAS 105, such as a location of UE 103, an identifier of UE 103 (e.g., an MDN, an International Mobile Subscriber Identity (“IMSI”), an IMEI, or the like), and/or other suitable network-generated or network-maintained information.

MFAS 105 may accordingly authenticate (at 512) UE 103 based on the implemented security mechanisms and the security policy for the given access type. For example, MFAS 105 may determine that the security mechanisms match, meet, satisfy, etc. the security mechanisms specified for the particular access type. MFAS 105 may also authenticate UE 103 and/or security card 101, such as by verifying information received (at 506) based on a tap of security card 101 to UE 103, a security token 301 received (at 508) from UE 103, and/or information received (at 510) from NBAS 501. In some embodiments, when MFAS 105 has authenticated (at 512) UE 103 and/or security card 101, MFAS 105 may generate and/or output one or more tokens, signatures, and/or other indications to UE 103 and/or security card 101 have been authenticated. For example, MFAS 105 may output such information to UE 103 (e.g., which may forward such information to an application server or some other suitable resource, such as an application server to which UE 103 is requesting access). Additionally, or alternatively, MFAS 105 may output such information and/or some other device or system, such as to an application server to which UE 103 is requesting access.

In some embodiments, UE 103 may implement some or all of the functionality of MFAS 105. For example, UE 103 may execute an application, firmware, API, etc. that performs one or more of the operations described above with respect to MFAS 105.

As mentioned above, MFAS 105 may determine a measure of authentication with respect to UE 103 on an ongoing basis. In this manner, MFAS 105 may determine a real-time authentication score associated with UE 103 based on one or more factors, such as tap-based authentication (e.g., using one or more security cards 101), token-based authentication (e.g., using one or more security tokens 301 associated with one or more respective security cards 101), ongoing network-provided information or network-based authentication mechanisms, or the like. The real-time authentication score may be used in conjunction with one or more access requests, such as a request by a user of UE 103 to access a web site or other type of resource, access an application server, etc.

For example, a relatively high real-time authentication score may indicate a relatively high measure of trust, authentication, etc. of UE 103 and/or a user thereof. On the other hand, a relatively low real-time authentication score may indicate a relatively low measure of trust, authentication, etc. of UE 103 and/or the user thereof.

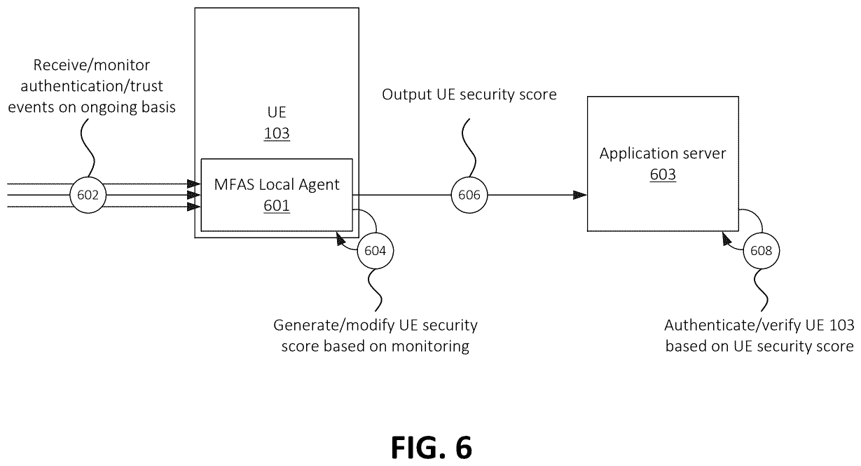

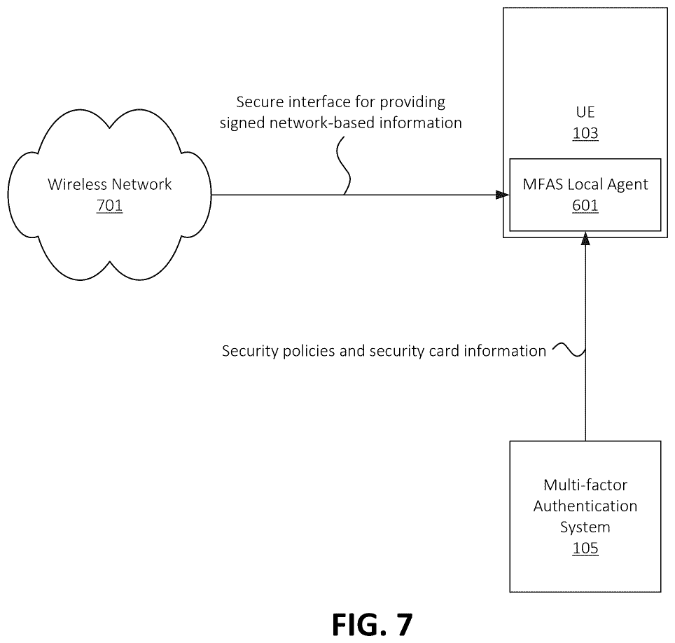

In some embodiments, as noted above, one or more of the functions of MFAS 105 may be implemented by one or more UEs 103. As shown in FIG. 6, for example, UE 103 may include or implement MFAS Local Agent 601, which may perform one or more of the functions of MFAS 105 discussed above. In this example, MFAS Local Agent 601 may receive and/or monitor (at 602) authentication events, trust events, or other suitable information on an ongoing basis. For example, as shown in FIG. 7, MFAS Local Agent 601 may receive, via a secure interface, network-based information from wireless network 701. Wireless network 701 may include, for example, a core network that provides authentication services, traffic routing services, location-based services, or the like. Wireless network 701 may include a RAN that provides wireless connectivity between UE 103 and the core network.

Wireless network 701 may include one or more authentication systems, such as an Authentication Server Function (“AUSF”), that are able to communicate with secure elements of UE 103 (e.g., a SIM card, an eSIM, etc.) in order to authenticate UE 103. Wireless network 701 may additionally include one or more mobility management elements, such as an Access and Mobility Management Function (“AMF”) or a Mobility Management Entity (“MME”), that are able to monitor the location of UE 103. Wireless network 701 may include one or more other elements that are able to determine or provide other information associated with UE 103.

In some embodiments, wireless network 701 may securely communicate with UE 103 (e.g., MFAS Local Agent 601) via a Network Exposure Function (“NEF”), a Service Capability Exposure Function (“SCEF”), or some other suitable interface via which devices external to wireless network 701 may communicate with elements of wireless network 701. Wireless network 701 may, for example, provide network-based information to MFAS Local Agent 601, such as an indication that UE 103 has been authenticated by wireless network 701 (e.g., using a SIM-based authentication procedure or some other suitable authentication procedure), an indication of the location of UE 103, and/or UE information. Wireless network 701 may provide such information on an ongoing basis, such as periodically (e.g., every hour, every minute, etc.), intermittently, on an event-driven basis (e.g., when the location of UE 103 changes), or the like.

In some embodiments, wireless network 701 may cryptographically sign information provided to UE 103 (e.g., to MFAS Local Agent 601). For example, wireless network 701 may utilize a private key to generate a digital signature, which may be used to verify the provenance of information bearing the digital signature. The digital signature may be included in, for example, messages that include network-based authentication information of UE 103, location information of UE 103, and/or other suitable information provided by wireless network 701.

MFAS Local Agent 601 may also be communicatively coupled to one or more other devices or systems, such as MFAS 105, an application server, or the like. For example, as shown, MFAS Local Agent 601 may receive security policies (e.g., as discussed above at 110) associated with one or more security cards 101 or security tokens 301 that have been registered or associated with UE 103, updated information associated with security cards 101, etc. In some embodiments, for example, MFAS 105 may receive or maintain an authentication or trust score for one or more security cards 101 that have been registered with or provided by (e.g., at 102) MFAS 105. As one example, MFAS 105 may generate the authentication or trust score for a given security card 101 based on factors such as age of security card 101 (e.g., how long security card 101 has been active, in service, etc.), types of security mechanisms implemented by security card 101 (e.g., encryption protocols or number of bits of encryption used), etc. Additionally, or alternatively, wireless network 701 and/or some other entity may maintain or provide authentication or trust scores associated with particular security cards 101 or with respective MFASs 105, and may provide such information to MFAS Local Agent 601 on an ongoing, real-time basis.

In some embodiments, multiple MFASs 105 may provide such information to UE 103 (and/or wireless network 701 may maintain or provide information regarding multiple MFASs 105). For example, a first MFAS 105 may issue a first security card 101 to a user of UE 103, and a second MFAS 105 may issue a second security card 101 to the user of UE 103. MFASs 105 may separately provide authentication or trust scores, associated with their respective issued security cards 101, to UE 103 (e.g., to MFAS Local Agent 601). Additionally, or alternatively, wireless network 701 may generate authentication or trust scores for each respective MFAS 105, and provide such information to UE 103 (e.g., to MFAS Local Agent 601). For example, wireless network 701 may identify that a given MFAS 105 has been compromised or is otherwise not secure, may lower a score associated with such MFAS 105, and may provide the lowered score to UE 103. In this manner, MFAS Local Agent 601 may aggregate authentication or trust-based information from multiple sources, including wireless network 701 and potentially multiple MFASs 105, on an ongoing basis.

Returning to FIG. 6, MFAS Local Agent 601 may generate or modify (at 604) a UE security score based on the received or monitored (at 602) information. For example, MFAS Local Agent 601 may utilize artificial intelligence/machine learning (“AI/ML”) techniques, modeling techniques, or other suitable techniques to generate or modify the security score for UE 103. In general, the security score may indicate a measure of authentication, security, trust, etc. for UE 103 as a whole, based on diverse sets of information that are not otherwise readily able to be aggregated. For example, as discussed above, the security score may be based on network-provided information (e.g., as provided by wireless network 701, NBAS 501, etc.) and/or information associated with each respective security card 101 or MFAS 105 that has been registered with UE 103.

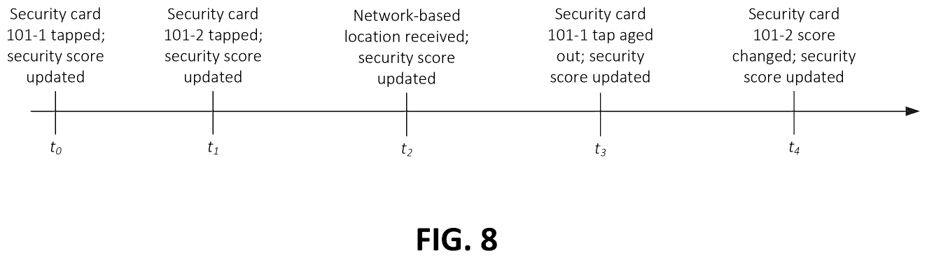

FIG. 8 illustrates an example of generating or modifying the security score over time, based on one or more events or monitored information. As shown, at a time t₀, a first security card 101-1 may be tapped at UE 103. MFAS Local Agent 601 may generate or modify a trust score for UE 103 based on the tap of security card 101-1. For example, MFAS Local Agent 601 may modify the trust score to reflect that security card 101-1 was physically tapped at UE 103 at this particular time. In some embodiments, the modifying of the trust score may be based on a score or other measure of security associated with security card 101-1, and/or with a given MFAS 105 that has issued (or is associated with) security card 101-1. For example, if security card 101-1 was issued by a given MFAS 105 that is associated with a relatively low measure of security, the trust score for UE 103 may be minimally increased (or not increased at all, or potentially decreased) by MFAS Local Agent 601. On the other hand, if security card 101-1 was issued by a given MFAS 105 that is associated with a relatively high measure of security, the trust score for UE 103 may be increased (or increased more than the above situation in which MFAS 105 has a relatively low measure of security).

As further shown, another security card 101-2 may be tapped at time t₁, and MFAS Local Agent 601 may modify the security score of UE 103 accordingly. For example, as similarly discussed above, modifying the security score of UE 103 based on the tap of security card 101-2 may be based on factors such as the physical tapping of security card 101-2, a security score associated with a respective MFAS 105 that issued security card 101-2, and/or other suitable factors.

As additionally shown in FIG. 8, MFAS Local Agent 601 may receive a network-based location of UE 103. For example, as discussed above, MFAS Local Agent 601 may receive such information from wireless network 701 and/or some other suitable source. MFAS Local Agent 601 may, for example, maintain one or more models or other information associated with UE 103, indicating a measure of likelihood that the location of UE 103 matches an “expected” location, such as locations included in a profile associated with UE 103. Additionally, or alternatively, MFAS Local Agent 601 may receive an indication from wireless network 701 of a measure of likelihood that the location of UE 103 is a secure location, is an expected location, is an unexpected location, etc. For example, if UE 103 is at an unexpected location at time t₂ (e.g., based on a profile or location history of UE 103), the security score of UE 103 may be lowered (e.g., indicating less security of UE 103). On the other hand, if UE 103 is at an expected location at time t₂, the security score of UE 103 may be increased.

As further shown, the amount of time between the tapping of security card 101-1 (at time t₀) and a subsequent time (e.g., time t₃) may exceed a threshold duration of time. In some embodiments, one or more security policies may specify this threshold duration of time. In this sense, the tap of security card 101-1 may be “aged out” at time t₃, and the security score for UE 103 may be adjusted accordingly. For example, the security score for UE 103 may be lowered based on the aging out of security card 101-1. In some embodiments, MFAS Local Agent 601 may output a notification that security card 101-1 has aged out, based on which a user of UE 103 may again tap security card 101-1 in order to reinstate or refresh security card 101-1, which may revert the lowering of the security score for UE 103 based on the aging out of security card 101-1.

In some situations, a measure of security associated with a given MFAS 105 may be changed. For example, as discussed above, MFAS Local Agent 601 may receive (e.g., from wireless network 701 or some other suitable source) an indication that a security score for the respective MFAS 105, with which security card 101-2 is associated, has changed. A particular MFAS 105 may, as one example, undergo a security-based event such as a “hack” or some other type of event, and a security score for such MFAS 105 may be lowered based on the occurrence of the event. As another example, a decay or growth function may be applied to the security score for a particular MFAS 105, in which the security score gradually increases or decreases over time.

The example events shown in FIG. 8 are provided for illustrative purposes. In practice, other types of events or monitored information may be used (e.g., by MFAS Local Agent 601) to generate or modify a security score for UE 103. Additionally, in some embodiments, one or more other devices or systems may generate or modify the security score for UE 103, such as MFAS 105 and/or one or more elements of wireless network 701.

In some embodiments, generating or modifying (at 604) the security score may include maintaining a measure of verification, by wireless network 701, of the UE security score and/or of information pertaining to factors used to determine the UE security score. For example, as discussed above, MFAS Local Agent 601 may receive, from wireless network 701, one or more certificates, keys, signatures, or the like, along with network-based information (e.g., when receiving such information from wireless network 701, as discussed above with respect to FIG. 7).

Returning to FIG. 6, MFAS Local Agent 601 may output (at 606) the UE security score. In this example, UE 103 (e.g., MFAS Local Agent 601) may output the security score for UE 103 to application server 603. For example, application server 603 may be a resource for which UE 103 is requesting access. Application server 603 may, for example, provide a network-accessible resource such as a web page, and a web browser application executing on UE 103 may have received a request (e.g., from a user of UE 103 and/or another application executing on UE 103) to access the web page. In some embodiments, MFAS Local Agent 601 may receive the access request and/or an identifier of application server 603 (e.g., a URL, an IP address, etc.) via the web browser application and/or some other application executing on UE 103. In some embodiments, UE 103 may associate MFAS Local Agent 601 with a particular IP address and/or port number, and may include the IP address and/or port number (e.g., as a callback IP address and/or port number) in an access request to application server 603.

Application server 603 may request the UE security score from MFAS Local Agent 601 based on receiving the access request (e.g., from MFAS Local Agent 601 and/or from some other element of UE 103). In some embodiments, application server 603 may make such request using a callback IP address and/or port number associated with MFAS Local Agent 601. Additionally, or alternatively, MFAS Local Agent 601 may identify that application server 603 is associated with a particular security policy specifying that the UE security score should be provided to application server 603, and may accordingly include the UE security score with an access request to application server 603. In some embodiments, outputting (at 606) the UE security score may be in conjunction with UE 103 performing one or more other authentication mechanisms specified by a security policy associated with the access request (e.g., a tap of security card 101, the use of a particular security token 301, etc., as discussed above.

In some embodiments, the UE security score may be a factor based on which a particular access type is associated. For example, a first access type (e.g., as discussed above with respect to FIG. 4) may be specified when the UE security score is above a particular threshold, and a second access type may be specified when the UE security score is below the particular threshold. For example, if the UE security score is relatively high, the use of security token 301 may be permitted (e.g., without requiring a tap of security card 101), while if the UE security score is relatively low, a tap of security card 101 may be required.

Application server 603 may authenticate and/or verify (at 608) UE 103 based on the UE security score and/or based on one or more other authentication mechanisms. For example, MFAS Local Agent 601 may utilize the UE security score itself as an authentication verification of UE 103. For example, in embodiments where the UE security score is signed by wireless network 701 and/or is based on verifiable information from wireless network 701, the presence of such signature or information along with the UE security score may satisfy a security policy associated with the access request. In some embodiments, application server 603 may otherwise utilize the security score as a factor upon which UE 103 is authenticated.

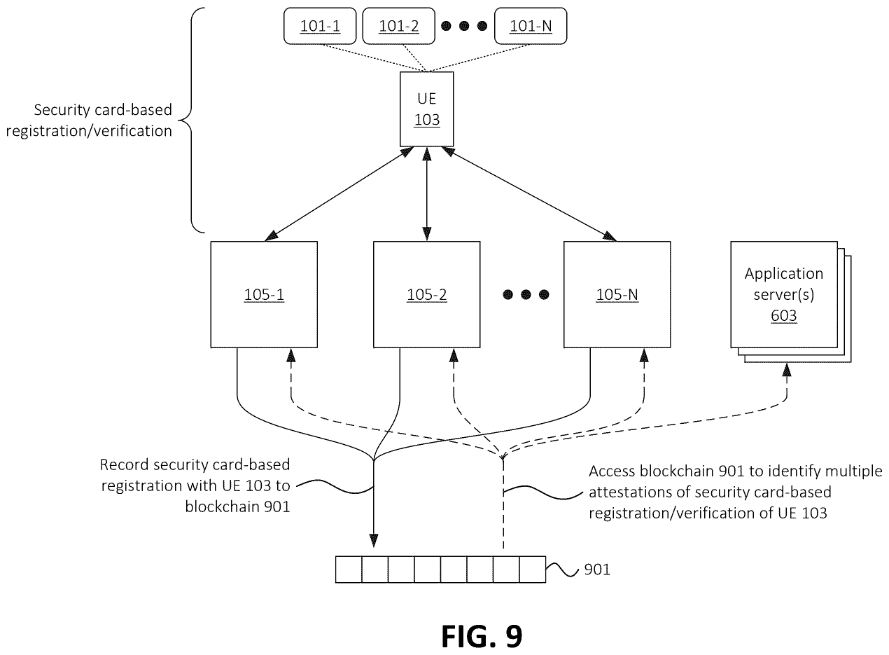

In some embodiments, a blockchain may be used to aggregate and/or provide security based information associated with UE 103 over time. For example, as shown in FIG. 9, one or more MFASs 105 (e.g., MFAS 105-1, MFAS 105-2, and MFAS 105-N) may have access blockchain 901. For example, in implementations where blockchain 901 is a permission-based blockchain, MFASs 105 may have authorization or permission to record information to blockchain 901. In some embodiments, one or more other devices or systems may have access to record information to blockchain 901, such as UEs 103 (e.g., respective MFAS Local Agents 601). As discussed above, UE 103 may register respective security cards 101 with MFASs 105. For example, UE 103 may register (e.g., via a tap-based registration, as discussed above) security card 101-1 with MFAS 105-1, security card 101-2 with MFAS 105-2, and so on. MFASs 105 may be independent, such as owned or operated by separate entities, and may not necessarily communicate with each other or directly provide information to each other. In accordance with some embodiments, each MFAS 105 may record information to blockchain 901, indicating the registration of respective security cards 101 with UE 103. In this manner, MFASs 105 and/or other devices or systems (e.g., application servers 603) may be able to identify that UE 103 has been associated or registered with multiple security cards 101. In some embodiments, a UE security score may be generated or modified based on the registration of UE 103 with multiple security cards 101 (e.g., in a similar manner as discussed above).

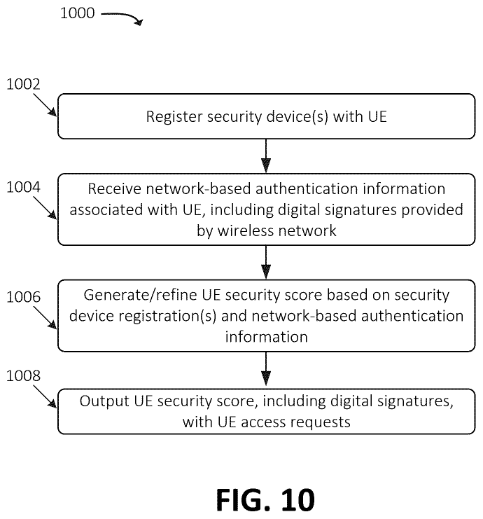

FIG. 10 illustrates an example process 1000 for maintaining and using a real-time security score for one or more UEs 103. In some embodiments, some or all of process 1000 may be performed by one or more UEs 103 (e.g., one or more respective MFAS Local Agents 601). In some embodiments, one or more other devices may perform some or all of process 1000 in concert with and/or in lieu of UE 103, such as one or more MFASs 105.

As shown, process 1000 may include registering (at 1002) one or more security devices (e.g., one or more security cards 101) with UE 103. For example, as discussed above, UE 103 may wirelessly communicate with one or more security cards 101, such as via an NFC tap or other type of wireless communication. The wireless communication may include security card 101 providing information, such as information generated or maintained by a secure element (e.g., an EMV chip) of security card 101, to UE 103 and/or to MFAS 105 (e.g., UE 103 may forward such information to MFAS 105). As discussed above, MFAS 105 and/or MFAS Local Agent 601 may maintain information indicating that security card 101 has been registered with UE 103, which may be based on identifying that UE 103 has provided verifiable information that UE 103 has wirelessly communicated with security card 101 (e.g., via an NFC tap or some other suitable communication). As discussed above, multiple security cards 101 may be registered with UE 103 in a similar manner.

Process 1000 may further include receiving (at 1004) network-based authentication information associated with UE 103. As discussed above, such information may include or may be generated based on one or more digital signatures, certificates, keys, or some other suitable authentication or verification mechanism based on which the attestation or provenance of the information by a particular wireless network 701 may be verified. The network-based authentication information may include, as discussed above, a verification by wireless network 701 of one or more identifiers of UE 103 (e.g., an MDN, an IMSI, an IMEI, etc.), a report of the location of UE 103, a profile of UE 103, and/or some other suitable information that is generated or provided by wireless network 701. As discussed above, UE 103 may receive such network-based information on an ongoing basis (e.g., on a periodic basis, an intermittent basis, an event-driven basis, etc.).

Process 1000 may additionally include generating, modifying, refining, etc. (at 1006) a UE security score based on the registration or registration of one or more security cards 101, as well as the network-based authentication information received over time. As discussed above, UE 103 (e.g., MFAS Local Agent 601, MFAS 105, and/or some other device or system) may utilize AI/ML techniques or other suitable techniques to generate, modify, etc. the UE security score based on factors associated with the particular security cards 101 registered with UE 103, information included in the network-based authentication information, and/or other suitable factors.

Process 1000 may also include outputting (at 1008) the UE security score, including the digital signature(s) provided by wireless network 701, in conjunction with one or more UE access requests. For example, as discussed above, UE 103 may provide the UE security score pursuant to, or in conjunction with, a request to access a particular network-accessible resource, such as a web page, a file, or other suitable network-accessible resources. A recipient of the access request, such as application server 603, may determine whether to grant (e.g., accept) or deny (e.g., not accept) the access request based on the UE security score and/or one or more other factors, as discussed above.

In this manner, UE 103 may maintain an up-to-date, real-time security score that reflects that level of security of UE 103. Further, since the security score includes, and/or is otherwise based on, verifiable network-based authentication information (e.g., including one or more digital signatures or other suitable verification information of wireless network 701), a level of trustworthiness or reliability of wireless network 701 may be imputed onto the security score itself. Thus, in some embodiments, the security score itself (e.g., which may include or may be based on the digital signature(s) provided by wireless network 701) may be used as an authentication mechanism for UE 103. In other scenarios, the security score may be a factor based on which the network-accessible resource verifies authentication of UE 103.

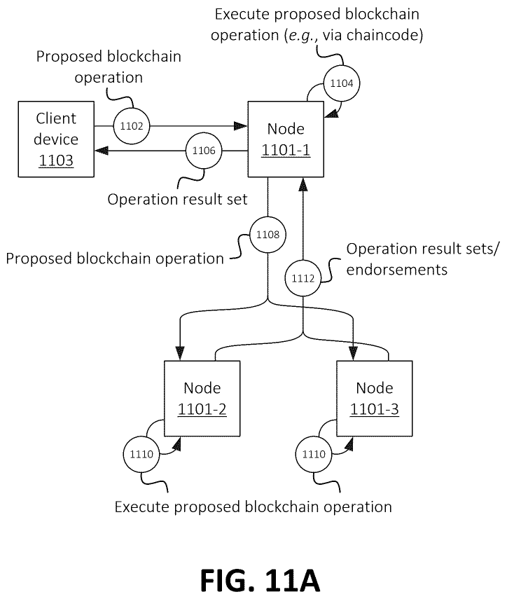

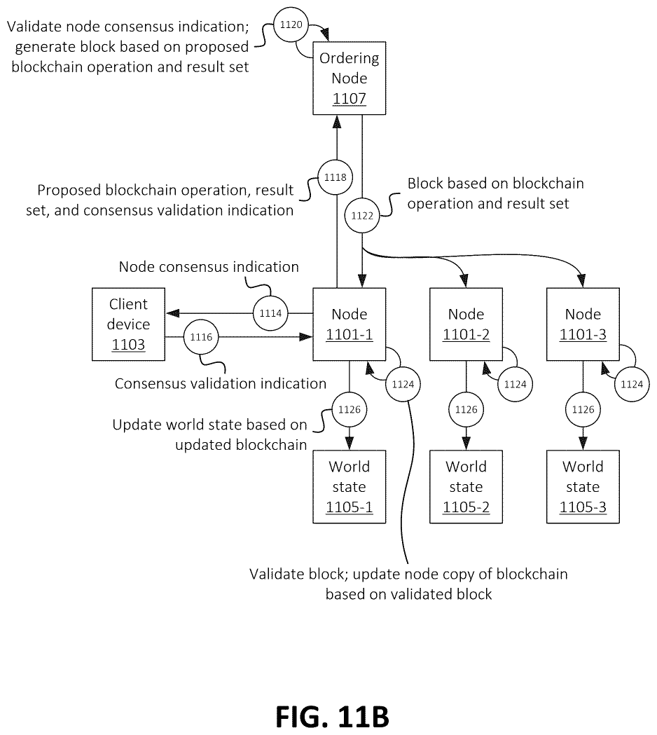

FIGS. 11A and 11B illustrate an example of modifying blockchain 901 and/or world state information based on an interaction with blockchain 901. As shown, a particular node 1101-1 may receive (at 1102) a proposed blockchain operation (e.g., a request to access or record information to blockchain 901) from a particular source, such as MFAS 105, client device 1103 (e.g., which may be or may be implemented by a device or system that has access to node 1101-1, such as a device or system that has authentication credentials, locator information, etc. via which client device 1103 is able to interact with node 1101-1), and/or some other source. In some embodiments, node 1101-1 may receive the proposed blockchain operation from a blockchain management system (e.g., which may receive the proposed blockchain operation from MFAS 105 or client device 1103 and may select node 1101-1 out of a group of nodes 1101, such as a group of nodes associated with the same channel in a channel-based blockchain system, such as the Hyperledger® Fabric), an ordering node, or other suitable device or system.

Client device 1103 may be, for example, an entity associated with blockchain 901 (e.g., may be associated with an address, a “wallet,” a decentralized application (“dApp”), etc.). In this example, assume that client device 1103 is authorized to initiate, request, etc. the proposed blockchain operation, which may include the modification of one or more values of one or more attributes that are currently associated with blockchain 901, the addition of one or more attributes to blockchain 901, or other suitable interactions. In other examples, node 1101-1 and/or some other device or system may verify that client device 1103 is authorized to initiate the proposed blockchain operation.

In some embodiments, the proposed blockchain operation (received at 1102) may indicate or refer to chaincode recorded to blockchain 901, which may specify one or more inputs (e.g., types of inputs, quantity of inputs, and/or other input parameters), and may also include actions to take with respect to the inputs in order to generate one or more outputs (e.g., chaincode). For example, the proposed blockchain operation may specify particular chaincode (e.g., an address or reference associated with blockchain 901 that includes a record with which the chaincode is associated, a name or identifier of the particular chaincode, or the like) and one or more input values according to input parameters specified by the particular chaincode. In some examples, the proposed blockchain operation may refer to one or more values that have previously been recorded to blockchain 901 (and thus reflected in world state information associated with blockchain 901), such as an interaction that increments or decrements previously recorded values or performs other computations based on previously recorded values.

Node 1101-1 may execute (at 1104) the proposed blockchain operation, which may include accessing the one or more values that were previously recorded to blockchain 901. In order to determine the one or more values referred to in the proposed blockchain operation, node 1101-1 may access world state information, maintained by node 1101-1, to determine such values. Such access may include checking a local cache and/or accessing, via a network, a remote system (e.g., a “cloud” system, a containerized system, etc.) associated with node 1101-1 that maintains the world state associated with blockchain 901. The execution (at 1104) may be a “simulation” of the proposed blockchain operation, inasmuch as the execution and of the proposed blockchain operation and the ensuing result may not yet be recorded to blockchain 901. The interaction may become “final” or “committed” based on validation by one or more other nodes. The result may include a “read-write set,” which may include the values of the one or more attributes that were accessed (e.g., the values based on which the interaction was performed), as well as the resulting values after execution of the proposed interaction.

Node 1101-1 may provide (at 1106) the result set (e.g., the read-write set) based on executing (at 1104) the proposed interaction to client device 1103. Client device 1103 may maintain the result set to, for example, verify and/or to provide approval of the result set before the result set is committed to blockchain 901. Node 1101-1 may also provide (at 1108) the proposed blockchain operation to one or more other nodes 1101 associated with blockchain 901, such as nodes 1101-2 and 1101-3. In some embodiments, node 1101-1 may provide (at 1108) the result set generated by node 1101-1 to nodes 1101-2 and 1101-3. Nodes 1101-1 through 1101-3 may all be associated with the same channel, nodes 1101-2 and 1101-3 may be specified by the chaincode as validators, and/or nodes 1101-2 and 1101-3 may otherwise be identified by node 1101-1 or an associated blockchain management system as nodes that should validate, endorse, etc. the execution and result of the proposed interaction.

As similarly discussed with respect to node 1101-1, nodes 1101-2 and 1101-3 may execute (at 1110), and/or simulate the execution of, the proposed interaction. Accordingly, nodes 1101-2 and 1101-3 may access one or more values that were previously recorded to blockchain 901 using world state information maintained by nodes 1101-2 and 1101-3. Nodes 1101-2 and 1101-3 may validate, verify, etc. the result set generated by node 1101-1 by comparing the result set with respective result sets generated by nodes 1101-2 and 1101-3. Nodes 1101-2 and 1101-3 may respond (at 1112) to node 1101-1 with respective result sets generated by nodes 1101-2 and 1101-3, and/or may respond with an indication, endorsement, etc. (e.g., which may be respectively signed by nodes 1101-2 and 1101-3) that the result set generated by node 1101-1 is valid. Once node 1101-1 has received endorsements from at least a threshold quantity of other nodes (e.g., from nodes 1101-2 and 1101-3, in this example), node 1101-1 may determine that a consensus has been reached with respect to the result set for the proposed interaction.

As shown in FIG. 11B, node 1101-1 may accordingly provide (at 1114), to client device 1103, an indication that consensus for the result set (provided at 1106) has been reached. In some embodiments, client device 1103 may validate the consensus (e.g., by evaluating signatures of nodes 1101-2 and 1101-3) and/or may verify the result set (e.g., by itself executing the proposed interaction). Client device 1103 may provide (at 1116), to node 1101-1, an indication that client device 1103 has validated the consensus and/or has verified the result set. In some embodiments, the consensus validation indication may be signed by client device 1103, thus securely authenticating the validation by client device 1103.

Node 1101-1 may provide (at 1118) the result set, along with the consensus validation indication and the proposed blockchain operation, to ordering node 1107. Ordering node 1107 may be a node, associated with the same channel as nodes 1101-1 through 1101-3, that validates (at 1120) the consensus validation indication (e.g., validates signatures associated with client device 1103 and/or nodes 1101-1 through 1101-3) and generates a block, to be recorded to blockchain 901, that includes information regarding the blockchain operation. Such information may include an identifier of client device 1103 (e.g., an address, wallet identifier, etc.), identifiers of nodes 1101-1 through 1101-3 that participated in generating and/or validating the result set based on the blockchain operation, chaincode inputs provided by client device 1103, the consensus validation indication, one or more timestamps of the above operations and/or other events, and/or other suitable information associated with the blockchain operation. In some embodiments, the block may be signed by ordering node 1107, thus securely authenticating the block creation by ordering node 1107. At this point, the blockchain operation may no longer be a “proposed” blockchain operation, as the interaction has been finalized, committed, etc. by ordering node 1107. In some implementations, nodes 1101-1 through 1101-3 may be referred to as “peers,” to indicate that such nodes 1101-1 through 1101-3 are distinct from ordering node 1107 (e.g., ordering node 1107 performs one or more different operations from the peers).

Ordering node 1107 may propagate (at 1122) the signed block, including information regarding the finalized blockchain operation initiated by client device 1103, to nodes 1101-1 through 1101-3 and/or other nodes associated with the same channel. Nodes 1101-1 through 1101-3 may validate (at 1124) the block, which may include verifying the signature of ordering node 1107, and may accordingly update a respective copy of blockchain 901 as maintained by each one of nodes 1101-1 through 1101-3. Nodes 1101-1 through 1101-3 may maintain respective independent copies of blockchain 901, thus providing an element of decentralization to blockchain 901. As such, when adding the block (received at 1122), nodes 1101-1 through 1101-3 may continue to maintain separate copies of the same blockchain 901, including the information regarding the finalized blockchain operation.

Nodes 1101-1 through 1101-3 may also maintain respective world state information 1105 (e.g., world state information 1105-1, 1105-2, and 1105-3). For example, world state information 1105 may include a portion of the information stored in blockchain 901, such as the latest version of some or all of the attributes for which information has been recorded to blockchain 901. Nodes 1101-1 through 1101-3 may accordingly update (at 1126) respective copies of world state information 1105 based on the received block. For example, in the event that the block includes a change in the value of a particular attribute, nodes 1101-1 through 1101-3 may update world state information 1105-1 through 1105-3, respectively, to replace a previous value of the attribute (e.g., a previous version of the attribute) with the newly received value of the particular attribute.

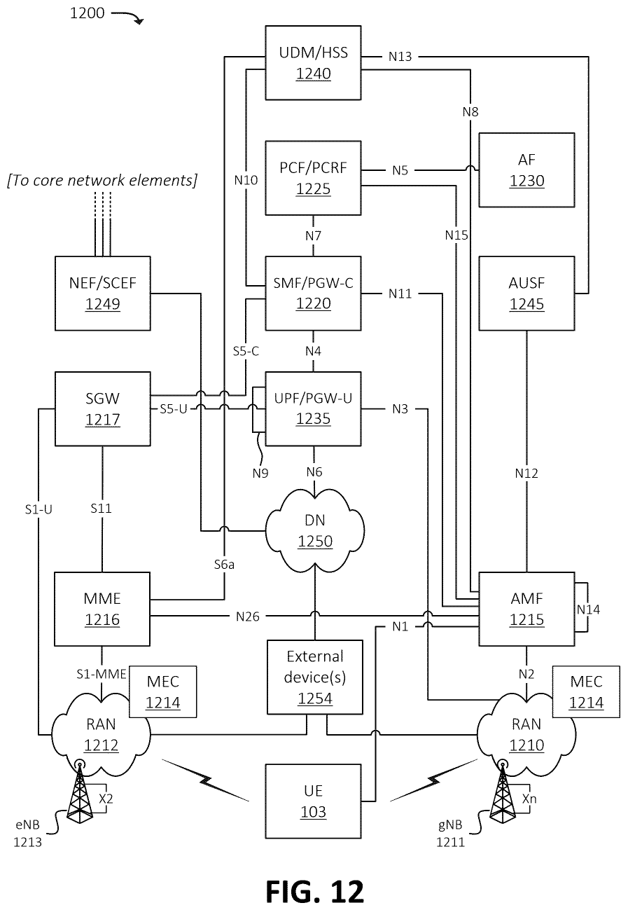

FIG. 12 illustrates an example environment 1200, in which one or more embodiments may be implemented. In some embodiments, environment 1200 may correspond to a Fifth Generation (“5G”) network, and/or may include elements of a 5G network. In some embodiments, environment 1200 may correspond to a 5G Non-Standalone (“NSA”) architecture, in which a 5G radio access technology (“RAT”) may be used in conjunction with one or more other RATs (e.g., a Long-Term Evolution (“LTE”) RAT), and/or in which elements of a 5G core network may be implemented by, may be communicatively coupled with, and/or may include elements of another type of core network (e.g., an evolved packet core (“EPC”)). In some embodiments, portions of environment 1200 may represent or may include a 5G core (“5GC”). As shown, environment 1200 may include UE 103, RAN 1210 (which may include one or more Next Generation Node Bs (“gNBs”) 1211), RAN 1212 (which may include one or more evolved Node Bs (“eNBs”) 1213), and various network functions such as AMF 1215, MME 1216, Serving Gateway (“SGW”) 1217, Session Management Function (“SMF”)/Packet Data Network (“PDN”) Gateway (“PGW”)-Control plane function (“PGW-C”) 1220, Policy Control Function (“PCF”)/Policy Charging and Rules Function (“PCRF”) 1225, Application Function (“AF”) 1230, User Plane Function (“UPF”)/PGW-User plane function (“PGW-U”) 1235, Unified Data Management (“UDM”)/Home Subscriber Server (“HSS”) 1240, AUSF 1245, and NEF/SCEF 1249. Environment 1200 may also include one or more networks, such as Data Network (“DN”) 1250. Environment 1200 may include one or more additional devices or systems communicatively coupled to one or more networks (e.g., DN 1250), such as one or more external devices 1254.

The example shown in FIG. 12 illustrates one instance of each network component or function (e.g., one instance of SMF/PGW-C 1220, PCF/PCRF 1225, UPF/PGW-U 1235, UDM/HSS 1240, and/or AUSF 1245). In practice, environment 1200 may include multiple instances of such components or functions. For example, in some embodiments, environment 1200 may include multiple “slices” of a core network, where each slice includes a discrete and/or logical set of netwo functions (e.g., one slice may include a first instance of AMF 1215, SMF/PGW-C 1220, PCF/PCRF 1225, and/or UPF/PGW-U 1235, while another slice may include a second instance of AMF 1215, SMF/PGW-C 1220, PCF/PCRF 1225, and/or UPF/PGW-U 1235). The different slices may provide differentiated levels of service, such as service in accordance with different Quality of Service (“QoS”) parameters.

The quantity of devices and/or networks, illustrated in FIG. 12, is provided for explanatory purposes only. In practice, environment 1200 may include additional devices and/or networks, fewer devices and/or networks, different devices and/or networks, or differently arranged devices and/or networks than illustrated in FIG. 12. For example, while not shown, environment 1200 may include devices that facilitate or enable communication between various components shown in environment 1200, such as routers, modems, gateways, switches, hubs, etc. In some implementations, one or more devices of environment 1200 may be physically integrated in, and/or may be physically attached to, one or more other devices of environment 1200. Alternatively, or additionally, one or more of the devices of environment 1200 may perform one or more network functions described as being performed by another one or more of the devices of environment 1200.

Additionally, one or more elements of environment 1200 may be implemented in a virtualized and/or containerized manner. For example, one or more of the elements of environment 1200 may be implemented by one or more Virtualized Network Functions (“VNFs”), Cloud-Native Network Functions (“CNFs”), etc. In such embodiments, environment 1200 may include, may implement, and/or may be communicatively coupled to an orchestration platform that provisions hardware resources, installs containers or applications, performs load balancing, and/or otherwise manages the deployment of such elements of environment 1200. In some embodiments, such orchestration and/or management of such elements of environment 1200 may be performed by, or in conjunction with, the open-source Kubernetes® API or some other suitable virtualization, containerization, and/or orchestration system.

Elements of environment 1200 may interconnect with each other and/or other devices via wired connections, wireless connections, or a combination of wired and wireless connections. Examples of interfaces or communication pathways between the elements of environment 1200, as shown in FIG. 12, may include an N1 interface, an N2 interface, an N3 interface, an N4 interface, an N5 interface, an N6 interface, an N7 interface, an N8 interface, an N9 interface, an N10 interface, an N11 interface, an N12 interface, an N13 interface, an N14 interface, an N15 interface, an N26 interface, an S1-C interface, an S1-U interface, an S5-C interface, an S5-U interface, an S6a interface, an S11 interface, and/or one or more other interfaces. Such interfaces may include interfaces not explicitly shown in FIG. 12, such as Service-Based Interfaces (“SBIs”), including an Namf interface, an Nudm interface, an Npcf interface, an Nupf interface, an Nnef interface, an Nsmf interface, and/or one or more other SBIs. In some embodiments, environment 1200 may be, may include, may be implemented by, and/or may be communicatively coupled to network 701.

UE 103 may include a computation and communication device, such as a wireless mobile communication device that is capable of communicating with RAN 1210, RAN 1212, and/or DN 1250. UE 103 may be, or may include, a radiotelephone, a personal communications system (“PCS”) terminal (e.g., a device that combines a cellular radiotelephone with data processing and data communications capabilities), a personal digital assistant (“PDA”) (e.g., a device that may include a radiotelephone, a pager, Internet/intranet access, etc.), a smart phone, a laptop computer, a tablet computer, a camera, a personal gaming system, an Internet of Things (“IoT”) device (e.g., a sensor, a smart home appliance, a wearable device, a programmable logic controller or other industrial controller, a Machine-to-Machine (“M2M”) device, or the like), a Fixed Wireless Access (“FWA”) device, or another type of mobile computation and communication device. UE 103 may send traffic to and/or receive traffic (e.g., user plane traffic) from DN 1250 via RAN 1210, RAN 1212, and/or UPF/PGW-U 1235.

RAN 1210 may be, or may include, a 5G RAN that implements a 5G RAT and that includes one or more base stations (e.g., one or more gNBs 1211), via which UE 103 may communicate with one or more other elements of environment 1200. UE 103 may communicate with RAN 1210 via an air interface (e.g., as provided by gNB 1211). For instance, RAN 1210 may receive traffic (e.g., user plane traffic such as voice call traffic, data traffic, messaging traffic, etc.) from UE 103 via the air interface, and may communicate the traffic to UPF/PGW-U 1235 and/or one or more other devices or networks. Further, RAN 1210 may receive signaling traffic, control plane traffic, etc. from UE 103 via the air interface, and may communicate such signaling traffic, control plane traffic, etc. to AMF 1215 and/or one or more other devices or networks. Additionally, RAN 1210 may receive traffic intended for UE 103 (e.g., from UPF/PGW-U 1235, AMF 1215, and/or one or more other devices or networks) and may communicate the traffic to UE 103 via the air interface.

RAN 1212 may be, or may include, an LTE RAN that implements an LTE RAT and that includes one or more base stations (e.g., one or more eNBs 1213), via which UE 103 may communicate with one or more other elements of environment 1200. UE 103 may communicate with RAN 1212 via an air interface (e.g., as provided by eNB 1213). For instance, RAN 1212 may receive traffic (e.g., user plane traffic such as voice call traffic, data traffic, messaging traffic, signaling traffic, etc.) from UE 103 via the air interface, and may communicate the traffic to UPF/PGW-U 1235 (e.g., via SGW 1217) and/or one or more other devices or networks. Further, RAN 1212 may receive signaling traffic, control plane traffic, etc. from UE 103 via the air interface, and may communicate such signaling traffic, control plane traffic, etc. to MME 1216 and/or one or more other devices or networks. Additionally, RAN 1212 may receive traffic intended for UE 103 (e.g., from UPF/PGW-U 1235, MME 1216, SGW 1217, and/or one or more other devices or networks) and may communicate the traffic to UE 103 via the air interface.

One or more RANs of environment 1200 (e.g., RAN 1210 and/or RAN 1212) may include, may implement, and/or may otherwise be communicatively coupled to one or more edge computing devices, such as one or more Multi-Access/Mobile Edge Computing (“MEC”) devices (referred to sometimes herein simply as a “MECs”) 1214. MECs 1214 may be co-located with wireless network infrastructure equipment of RANs 1210 and/or 1212 (e.g., one or more gNBs 1211 and/or one or more eNBs 1213, respectively). Additionally, or alternatively, MECs 1214 may otherwise be associated with geographical regions (e.g., coverage areas) of wireless network infrastructure equipment of RANs 1210 and/or 1212. In some embodiments, one or more MECs 1214 may be implemented by the same set of hardware resources, the same set of devices, etc. that implement wireless network infrastructure equipment of RANs 1210 and/or 1212. In some embodiments, one or more MECs 1214 may be implemented by different hardware resources, a different set of devices, etc. from hardware resources or devices that implement wireless network infrastructure equipment of RANs 1210 and/or 1212. In some embodiments, MECs 1214 may be communicatively coupled to wireless network infrastructure equipment of RANs 1210 and/or 1212 (e.g., via a high-speed and/or low-latency link such as a physical wired interface, a high-speed and/or low-latency wireless interface, or some other suitable communication pathway).

MECs 1214 may include hardware resources (e.g., configurable or provisionable hardware resources) that may be configured to provide services and/or otherwise process traffic to and/or from UE 103, via RAN 1210 and/or 1212. For example, RAN 1210 and/or 1212 may route some traffic from UE 103 (e.g., traffic associated with one or more particular services, applications, application types, etc.) to a respective MEC 1214 instead of to core network elements of 1200 (e.g., UPF/PGW-U 1235). MEC 1214 may accordingly provide services to UE 103 by processing such traffic, performing one or more computations based on the received traffic, and providing traffic to UE 103 via RAN 1210 and/or 1212. MEC 1214 may include, and/or may implement, some or all of the functionality described above with respect to UPF/PGW-U 1235, AF 1230, one or more application servers, and/or one or more other devices, systems, VNFs, CNFs, etc. In this manner, ultra-low latency services may be provided to UE 103, as traffic does not need to traverse links (e.g., backhaul links) between RAN 1210 and/or 1212 and the core network.

AMF 1215 may include one or more devices, systems, VNFs, CNFs, etc., that perform operations to register UE 103 with the 5G network, to establish bearer channels associated with a session with UE 103, to hand off UE 103 from the 5G network to another network, to hand off UE 103 from the other network to the 5G network, manage mobility of UE 103 between RANs 1210 and/or gNBs 1211, and/or to perform other operations. In some embodiments, the 5G network may include multiple AMFs 1215, which communicate with each other via the N14 interface (denoted in FIG. 12 by the line marked “N14” originating and terminating at AMF 1215).

MME 1216 may include one or more devices, systems, VNFs, CNFs, etc., that perform operations to register UE 103 with the EPC, to establish bearer channels associated with a session with UE 103, to hand off UE 103 from the EPC to another network, to hand off UE 103 from another network to the EPC, manage mobility of UE 103 between RANs 1212 and/or eNBs 1213, and/or to perform other operations.

SGW 1217 may include one or more devices, systems, VNFs, CNFs, etc., that aggregate traffic received from one or more eNBs 1213 and send the aggregated traffic to an external network or device via UPF/PGW-U 1235. Additionally, SGW 1217 may aggregate traffic received from one or more UPF/PGW-Us 1235 and may send the aggregated traffic to one or more eNBs 1213. SGW 1217 may operate as an anchor for the user plane during inter-eNB handovers and as an anchor for mobility between different telecommunication networks or RANs (e.g., RANs 1210 and 1212).

SMF/PGW-C 1220 may include one or more devices, systems, VNFs, CNFs, etc., that gather, process, store, and/or provide information in a manner described herein. SMF/PGW-C 1220 may, for example, facilitate the establishment of communication sessions on behalf of UE 103. In some embodiments, the establishment of communications sessions may be performed in accordance with one or more policies provided by PCF/PCRF 1225.

PCF/PCRF 1225 may include one or more devices, systems, VNFs, CNFs, etc., that aggregate information to and from the 5G network and/or other sources. PCF/PCRF 1225 may receive information regarding policies and/or subscriptions from one or more sources, such as subscriber databases and/or from one or more users (such as, for example, an administrator associated with PCF/PCRF 1225).

AF 1230 may include one or more devices, systems, VNFs, CNFs, etc., that receive, store, and/or provide information that may be used in determining parameters (e.g., quality of service parameters, charging parameters, or the like) for certain applications.

UPF/PGW-U 1235 may include one or more devices, systems, VNFs, CNFs, etc., that receive, store, and/or provide data (e.g., user plane data). For example, UPF/PGW-U 1235 may receive user plane data (e.g., voice call traffic, data traffic, etc.), destined for UE 103, from DN 1250, and may forward the user plane data toward UE 103 (e.g., via RAN 1210, SMF/PGW-C 1220, and/or one or more other devices). In some embodiments, multiple instances of UPF/PGW-U 1235 may be deployed (e.g., in different geographical locations), and the delivery of content to UE 103 may be coordinated via the N9 interface (e.g., as denoted in FIG. 12 by the line marked “N9” originating and terminating at UPF/PGW-U 1235). Similarly, UPF/PGW-U 1235 may receive traffic from UE 103 (e.g., via RAN 1210, RAN 1212, SMF/PGW-C 1220, and/or one or more other devices), and may forward the traffic toward DN 1250. In some embodiments, UPF/PGW-U 1235 may communicate (e.g., via the N4 interface) with SMF/PGW-C 1220, regarding user plane data processed by UPF/PGW-U 1235.

UDM/HSS 1240 and AUSF 1245 may include one or more devices, systems, VNFs, CNFs, etc., that manage, update, and/or store, in one or more memory devices associated with AUSF 1245 and/or UDM/HSS 1240, profile information associated with a subscriber. In some embodiments, UDM/HSS 1240 may include, may implement, may be communicatively coupled to, and/or may otherwise be associated with some other type of repository or database, such as a Unified Data Repository (“UDR”). AUSF 1245 and/or UDM/HSS 1240 may perform authentication, authorization, and/or accounting operations associated with one or more UEs 103 and/or one or more communication sessions associated with one or more UEs 103.

DN 1250 may include one or more wired and/or wireless networks. For example, DN 1250 may include an IP-based PDN, a wide area network (“WAN”) such as the Internet, a private enterprise network, and/or one or more other networks. UE 103 may communicate, through DN 1250, with data servers, other UEs 103, and/or to other servers or applications that are coupled to DN 1250. DN 1250 may be connected to one or more other networks, such as a public switched telephone network (“PSTN”), a public land mobile network (“PLMN”), and/or another network. DN 1250 may be connected to one or more devices, such as content providers, applications, web servers, and/or other devices, with which UE 103 may communicate.

External devices 1254 may include one or more devices or systems that communicate with UE 103 via DN 1250 and one or more elements of 1200 (e.g., via UPF/PGW-U 1235). In some embodiments, external devices 1254 may include, may implement, and/or may otherwise be associated with MFAS 105, application server 603, client device 1103, nodes 1101, and/or other devices or systems. External devices 1254 may include, for example, one or more application servers, content provider systems, web servers, or the like. External devices 1254 may, for example, implement “server-side” applications that communicate with “client-side” applications executed by UE 103. External devices 1254 may provide services to UE 103 such as gaming services, videoconferencing services, messaging services, email services, web services, and/or other types of services. Operations described above with respect to a given external device 1254 (e.g., in accordance with some embodiments) may be performed by a single device, by a cloud computing system, by one or more devices that implement a virtualized or containerized environment, a collection of devices, etc.

In some embodiments, external devices 1254 may communicate with one or more elements of environment 1200 (e.g., core network elements) via NEF/SCEF 1249. NEF/SCEF 1249 include one or more devices, systems, VNFs, CNFs, etc. that provide access to information, APIs, and/or other operations or mechanisms of one or more core network elements to devices or systems that are external to the core network (e.g., to external device 1254 via DN 1250). NEF/SCEF 1249 may maintain authorization and/or authentication information associated with such external devices or systems, such that NEF/SCEF 1249 is able to provide information, that is authorized to be provided, to the external devices or systems. For example, a given external device 1254 may request particular information associated with one or more core network elements. NEF/SCEF 1249 may authenticate the request and/or otherwise verify that external device 1254 is authorized to receive the information, and may request, obtain, or otherwise receive the information from the one or more core network elements. In some embodiments, NEF/SCEF 1249 may include, may implement, may be implemented by, may be communicatively coupled to, and/or may otherwise be associated with a Security Edge Protection Proxy (“SEPP”), which may perform some or all of the functions discussed above. External device 1254 may, in some situations, subscribe to particular types of requested information provided by the one or more core network elements, and the one or more core network elements may provide (e.g., “push”) the requested information to NEF/SCEF 1249 (e.g., in a periodic or otherwise ongoing basis).

In some embodiments, external devices 1254 may communicate with one or more elements of RAN 1210 and/or 1212 via an API or other suitable interface. For example, a given external device 1254 may provide instructions, requests, etc. to RAN 1210 and/or 1212 to provide one or more services via one or more respective MECs 1214. In some embodiments, such instructions, requests, etc. may include QoS parameters, Service Level Agreements (“SLAs”), etc. (e.g., maximum latency thresholds, minimum throughput thresholds, etc.) associated with the services.

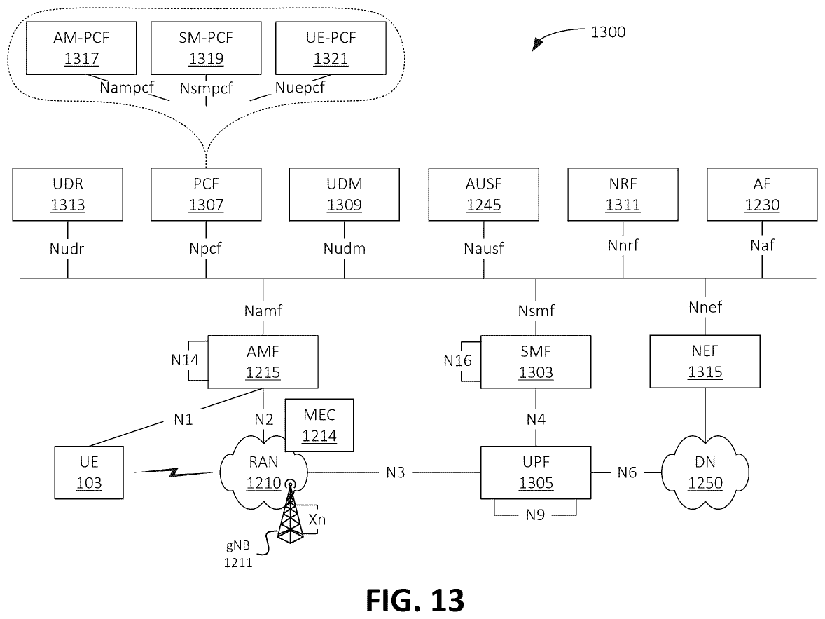

FIG. 13 illustrates another example environment 1300, in which one or more embodiments may be implemented. In some embodiments, environment 1300 may correspond to a 5G network, and/or may include elements of a 5G network. In some embodiments, environment 1300 may correspond to a 5G SA architecture. In some embodiments, environment 1300 may include a 5GC, in which 5GC network elements perform one or more operations described herein.

As shown, environment 1300 may include UE 103, RAN 1210 (which may include one or more gNBs 1211 or other types of wireless network infrastructure) and various network functions, which may be implemented as VNFs, CNFs, etc. Such network functions may include AMF 1215, SMF 1303, UPF 1305, PCF 1307, UDM 1309, AUSF 1245, Network Repository Function (“NRF”) 1311, AF 1230, UDR 1313, and NEF 1315. Environment 1300 may also include or may be communicatively coupled to one or more networks, such as DN 1250.

The example shown in FIG. 13 illustrates one instance of each network component or function (e.g., one instance of SMF 1303, UPF 1305, PCF 1307, UDM 1309, AUSF 1245, etc.). In practice, environment 1300 may include multiple instances of such components or functions. For example, in some embodiments, environment 1300 may include multiple “slices” of a core network, where each slice includes a discrete and/or logical set of network functions (e.g., one slice may include a first instance of SMF 1303, PCF 1307, UPF 1305, etc., while another slice may include a second instance of SMF 1303, PCF 1307, UPF 1305, etc.). Additionally, or alternatively, one or more of the network functions of environment 1300 may implement multiple network slices. The different slices may provide differentiated levels of service, such as service in accordance with different QoS parameters.

The quantity of devices and/or networks, illustrated in FIG. 13, is provided for explanatory purposes only. In practice, environment 1300 may include additional devices and/or networks, fewer devices and/or networks, different devices and/or networks, or differently arranged devices and/or networks than illustrated in FIG. 13. For example, while not shown, environment 1300 may include devices that facilitate or enable communication between various components shown in environment 1300, such as routers, modems, gateways, switches, hubs, etc. In some implementations, one or more devices of environment 1300 may be physically integrated in, and/or may be physically attached to, one or more other devices of environment 1300. Alternatively, or additionally, one or more of the devices of environment 1300 may perform one or more network functions described as being performed by another one or more of the devices of environment 1300.

Elements of environment 1300 may interconnect with each other and/or other devices via wired connections, wireless connections, or a combination of wired and wireless connections. Examples of interfaces or communication pathways between the elements of environment 1300, as shown in FIG. 13, may include interfaces shown in FIG. 13 and/or one or more interfaces not explicitly shown in FIG. 13. These interfaces may include interfaces between specific network functions, such as an N1 interface, an N2 interface, an N3 interface, an N6 interface, an N9 interface, an N14 interface, an N16interface, and/or one or more other interfaces. In some embodiments, one or more elements of environment 1300 may communicate via a service-based architecture (“SBA”), in which a routing mesh or other suitable routing mechanism may route communications to particular network functions based on interfaces or identifiers associated with such network functions. Such interfaces may include or may be referred to as SBIs, including an Namf interface (e.g., indicating communications to be routed to AMF 1215), an Nudm interface (e.g., indicating communications to be routed to UDM 1309), an Npcf interface, an Nupf interface, an Nnef interface, an Nsmf interface, an Nnrf interface, an Nudr interface, an Naf interface, and/or one or more other SBIs. In some embodiments, environment 1300 may be, may include, may be implemented by, and/or may be communicatively coupled to network 701.

UPF 1305 may include one or more devices, systems, VNFs, CNFs, etc., that receive, route, process, and/or forward traffic (e.g., user plane traffic). As discussed above, UPF 1305 may communicate with UE 103 via one or more communication sessions, such as PDU sessions. Such PDU sessions may be associated with a particular network slice or other suitable QoS parameters, as noted above. UPF 1305 may receive downlink user plane traffic (e.g., voice call traffic, data traffic, etc. destined for UE 103) from DN 1250, and may forward the downlink user plane traffic toward UE 103 (e.g., via RAN 1210). In some embodiments, multiple UPFs 1305 may be deployed (e.g., in different geographical locations), and the delivery of content to UE 103 may be coordinated via the N9 interface. Similarly, UPF 1305 may receive uplink traffic from UE 103 (e.g., via RAN 1210), and may forward the traffic toward DN 1250. In some embodiments, UPF 1305 may implement, may be implemented by, may be communicatively coupled to, and/or may otherwise be associated with UPF/PGW-U 1235. In some embodiments, UPF 1305 may communicate (e.g., via the N4 interface) with SMF 1303, regarding user plane data processed by UPF 1305 (e.g., to provide analytics or reporting information, to receive policy and/or authorization information, etc.).

PCF 1307 may include one or more devices, systems, VNFs, CNFs, etc., that aggregate, derive, generate, etc. policy information associated with the 5GC and/or UEs 103 that communicate via the 5GC and/or RAN 1210. PCF 1307 may receive information regarding policies and/or subscriptions from one or more sources, such as subscriber databases (e.g., UDM 1309, UDR 1313, etc.), and/or from one or more users such as, for example, an administrator associated with PCF 1307. In some embodiments, the functionality of PCF 1307 may be split into multiple network functions or subsystems, such as access and mobility PCF (“AM-PCF”) 1317, session management PCF (“SM-PCF”) 1319, UE PCF (“UE-PCF”) 1321, and so on. Such different “split” PCFs may be associated with respective SBIs (e.g., AM-PCF 1317 may be associated with an Nampcf SBI, SM-PCF 1319 may be associated with an Nsmpcf SBI, UE-PCF 1321 may be associated with an Nuepcf SBI, and so on) via which other network functions may communicate with the split PCFs. The split PCFs may maintain information regarding policies associated with different devices, systems, and/or network functions.

NRF 1311 may include one or more devices, systems, VNFs, CNFs, etc. that maintain routing and/or network topology information associated with the 5GC. For example, NRF 1311 may maintain and/or provide IP addresses of one or more network functions, routes associated with one or more network functions, discovery and/or mapping information associated with particular network functions or network function instances (e.g., whereby such discovery and/or mapping information may facilitate the SBA), and/or other suitable information.

UDR 1313 may include one or more devices, systems, VNFs, CNFs, etc. that provide user and/or subscriber information, based on which PCF 1307 and/or other elements of environment 1300 may determine access policies, QoS policies, charging policies, or the like. In some embodiments, UDR 1313 may receive such information from UDM 1309 and/or one or more other sources.

NEF 1315 include one or more devices, systems, VNFs, CNFs, etc. that provide access to information, APIs, and/or other operations or mechanisms of the 5GC to devices or systems that are external to the 5GC. NEF 1315 may maintain authorization and/or authentication information associated with such external devices or systems, such that NEF 1315 is able to provide information, that is authorized to be provided, to the external devices or systems. Such information may be received from other network functions of the 5GC (e.g., as authorized by an administrator or other suitable entity associated with the 5GC), such as SMF 1303, UPF 1305, a charging function (“CHF”) of the 5GC, and/or other suitable network function. NEF 1315 may communicate with external devices or systems (e.g., external devices 1254) via DN 1250 and/or other suitable communication pathways.

While environment 1300 is described in the context of a 5GC, as noted above, environment 1300 may, in some embodiments, include or implement one or more other types of core networks. For example, in some embodiments, environment 1300 may be or may include a converged packet core, in which one or more elements may perform some or all of the functionality of one or more 5GC network functions and/or one or more EPC network functions. For example, in some embodiments, AMF 1215 may include, may implement, may be implemented by, and/or may otherwise be associated with MME 1216; SMF 1303 may include, may implement, may be implemented by, and/or may otherwise be associated with SGW 1217; PCF 1307 may include, may implement, may be implemented by, and/or may otherwise be associated with a PCRF (e.g., PCF/PCRF 1225); NEF 1315 may include, may implement, may be implemented by, and/or may otherwise be associated with a SCEF (e.g., NEF/SCEF 1249); and so on.

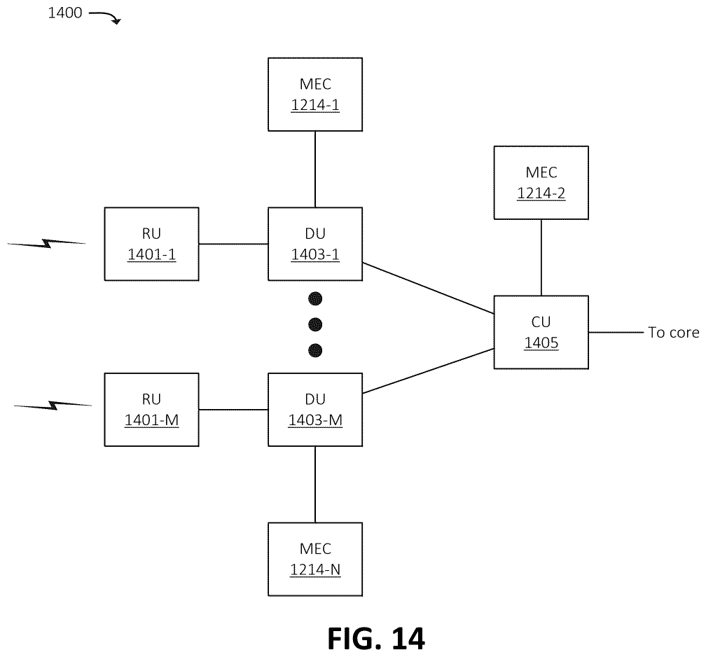

FIG. 14 illustrates an example RAN environment 1400, which may be included in and/or implemented by one or more RANs (e.g., RAN 1210 or some other RAN). In some embodiments, a particular RAN 1210 may include one RAN environment 1400. In some embodiments, a particular RAN 1210 may include multiple RAN environments 1400. In some embodiments, RAN environment 1400 may correspond to a particular gNB 1211 of RAN 1210. In some embodiments, RAN environment 1400 may correspond to multiple gNBs 1211. In some embodiments, RAN environment 1400 may correspond to one or more other types of base stations of one or more other types of RANs. As shown, RAN environment 1400 may include Central Unit (“CU”) 1405, one or more Distributed Units (“DUs”) 1403-1 through 1403-M (referred to individually as “DU 1403,” or collectively as “DUs 1403”), and one or more Radio Units (“RUs”) 1401-1 through 1401-M (referred to individually as “RU 1401,” or collectively as “RUs 1401”).

CU 1405 may communicate with a core of a wireless network (e.g., may communicate with one or more of the devices or systems described above with respect to FIG. 13, such as AMF 1215 and/or UPF 1305) and/or some other device or system such as MEC 1214. In the uplink direction (e.g., for traffic from UEs 103 to a core network), CU 1405 may aggregate traffic from DUs 1403, and forward the aggregated traffic to the core network. In some embodiments, CU 1405 may receive traffic according to a given protocol (e.g., Radio Link Control (“RLC”) traffic) from DUs 1403, and may perform higher-layer processing (e.g., may aggregate/process RLC packets and generate Packet Data Convergence Protocol (“PDCP”) packets based on the RLC packets) on the traffic received from DUs 1403.

CU 1405 may receive downlink traffic (e.g., traffic from the core network, traffic from a given MEC 1214, etc.) for a particular UE 103, and may determine which DU(s) 1403 should receive the downlink traffic. DU 1403 may include one or more devices that transmit traffic between a core network (e.g., via CU 1405) and UE 103 (e.g., via a respective RU 1401). DU 1403 may, for example, receive traffic from RU 1401 at a first layer (e.g., physical (“PHY”) layer traffic, or lower PHY layer traffic), and may process/aggregate the traffic to a second layer (e.g., upper PHY and/or RLC). DU 1403 may receive traffic from CU 1405 at the second layer, may process the traffic to the first layer, and provide the processed traffic to a respective RU 1401 for transmission to UE 103.

RU 1401 may include hardware circuitry (e.g., one or more RF transceivers, antennas, radios, and/or other suitable hardware) to communicate wirelessly (e.g., via an RF interface) with one or more UEs 103, one or more other DUs 1403 (e.g., via RUs 1401 associated with DUs 1403), and/or any other suitable type of device. In the uplink direction, RU 1401 may receive traffic from UE 103 and/or another DU 1403 via the RF interface and may provide the traffic to DU 1403. In the downlink direction, RU 1401 may receive traffic from DU 1403, and may provide the traffic to UE 103 and/or another DU 1403.

One or more elements of RAN environment 1400 may, in some embodiments, be communicatively coupled to one or more MECs 1214. For example, DU 1403-1 may be communicatively coupled to MEC 1214-1, DU 1403-M may be communicatively coupled to MEC 1214-N, CU 1405 may be communicatively coupled to MEC 1214-2, and so on. MECs 1214 may include hardware resources (e.g., configurable or provisionable hardware resources) that may be configured to provide services and/or otherwise process traffic to and/or from UE 103, via a respective RU 1401.

For example, DU 1403-1 may route some traffic, from UE 103, to MEC 1214-1 instead of to a core network via CU 1405. MEC 1214-1 may process the traffic, perform one or more computations based on the received traffic, and may provide traffic to UE 103 via RU 1401-1. As discussed above, MEC 1214 may include, and/or may implement, some or all of the functionality described above with respect to UPF 1305, AF 1230, and/or one or more other devices, systems, VNFs, CNFs, etc. In this manner, ultra-low latency services may be provided to UE 103, as traffic does not need to traverse DU 1403, CU 1405, links between DU 1403 and CU 1405, and an intervening backhaul network between RAN environment 1400 and the core network.

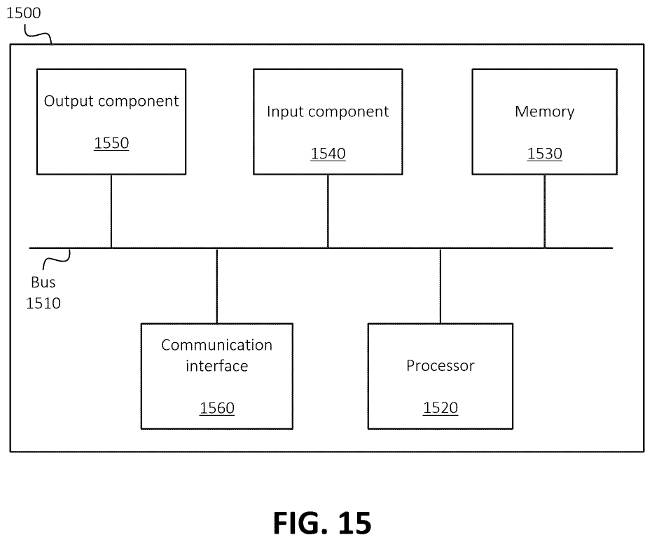

FIG. 15 illustrates example components of device 1500. One or more of the devices described above may include one or more devices 1500. Device 1500 may include bus 1510, processor 1520, memory 1530, input component 1540, output component 1550, and communication interface 1560. In another implementation, device 1500 may include additional, fewer, different, or differently arranged components.

Bus 1510 may include one or more communication paths that permit communication among the components of device 1500. Processor 1520 may include a processor, microprocessor, a set of provisioned hardware resources of a cloud computing system, a graphics processing unit (“GPU”), a GPU-based processing unit, a neural processing unit (“NPU”), or other suitable type of hardware that interprets and/or executes instructions (e.g., processor-executable instructions). In some embodiments, processor 1520 may be or may include one or more hardware processors. Memory 1530 may include any type of dynamic storage device that may store information and instructions for execution by processor 1520, and/or any type of non-volatile storage device that may store information for use by processor 1520.

Input component 1540 may include a mechanism that permits an operator to input information to device 1500 and/or other receives or detects input from a source external to input component 1540, such as a touchpad, a touchscreen, a keyboard, a keypad, a button, a switch, a microphone or other audio input component, etc. In some embodiments, input component 1540 may include, or may be communicatively coupled to, one or more sensors, such as a motion sensor (e.g., which may be or may include a gyroscope, accelerometer, or the like), a location sensor (e.g., a Global Positioning System (“GPS”)-based location sensor or some other suitable type of location sensor or location determination component), a thermometer, a barometer, and/or some other type of sensor. Output component 1550 may include a mechanism that outputs information to the operator, such as a display, a speaker, one or more light emitting diodes (“LEDs”), etc.

Communication interface 1560 may include any transceiver-like mechanism that enables device 1500 to communicate with other devices and/or systems (e.g., via RAN 1210, RAN 1212, DN 1250, etc.). For example, communication interface 1560 may include an Ethernet interface, an optical interface, a coaxial interface, or the like. Communication interface 1560 may include a wireless communication device, such as an infrared (“IR”) receiver, a Bluetooth® radio, or the like. The wireless communication device may be coupled to an external device, such as a cellular radio, a remote control, a wireless keyboard, a mobile telephone, etc. In some embodiments, device 1500 may include more than one communication interface 1560. For instance, device 1500 may include an optical interface, a wireless interface, an Ethernet interface, and/or one or more other interfaces.

Device 1500 may perform certain operations relating to one or more processes described above. Device 1500 may perform these operations in response to processor 1520 executing instructions, such as software instructions, processor-executable instructions, etc. stored in a computer-readable medium, such as memory 1530. A computer-readable medium may be defined as a non-transitory memory device. A memory device may include space within a single physical memory device or spread across multiple physical memory devices. The instructions may be read into memory 1530 from another computer-readable medium or from another device. The instructions stored in memory 1530 may be processor-executable instructions that cause processor 1520 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

For example, while series of blocks and/or signals have been described above (e.g., with regard to FIGS. 1-10), the order of the blocks and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

The actual software code or specialized control hardware used to implement an embodiment is not limiting of the embodiment. Thus, the operation and behavior of the embodiment has been described without reference to the specific software code, it being understood that software and control hardware may be designed based on the description herein.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A device, comprising:
one or more processors configured to:
wirelessly communicate with a security device;
maintain information indicating that the device has wirelessly communicated with the security device;
receive network-based authentication information associated with the device, wherein the network-based authentication information includes one or more digital signatures generated by a particular wireless network;
generate a security score for the device based on:
the information indicating that the device has wirelessly communicated with the security device, and
the network-based authentication information associated with the device; and
output, to a particular network-accessible resource, an access request, wherein outputting the access request includes outputting the security score and the one or more digital signatures generated by the particular wireless network, wherein the network-accessible resource accepts or denies the access request based on the security score and the one or more digital signatures generated by the particular wireless network.

2. The device of claim 1, wherein the security device includes a Europay, Mastercard, Visa (“EMV”) chip.

3. The device of claim 1, wherein wirelessly communicating with the security device includes communicating with the security device using a Near Field Communication (“NFC”) protocol.

4. The device of claim 1, wherein the network-based authentication information includes an indication that the wireless network has verified an identifier of the device.

5. The device of claim 4, wherein the identifier includes at least one of:
a Mobile Directory Number (“MDN”),
an International Mobile Station Equipment Identity (“IMEI”), or
an International Mobile Subscriber Identity (“IMSI”).

6. The device of claim 1, wherein the one or more processors are further configured to:
monitor or receive network-based authentication information associated with the device over time; and
modify the security score for the device on an ongoing basis based on the network-based authentication information received or monitored over time.

7. The device of claim 1, wherein the security device is a first security device, wherein the one or more processors are further configured to:
wirelessly communicate with a second security device; and
modify the security score for the device further based on wirelessly communicating with the second security device.

8. A non-transitory computer-readable medium, storing a plurality of processor-executable instructions to:
maintain information indicating that a device has wirelessly communicated with a security device;
receive network-based authentication information associated with the device, wherein the network-based authentication information includes one or more digital signatures generated by a particular wireless network;
generate a security score for the device based on:
the information indicating that the device has wirelessly communicated with the security device, and
the network-based authentication information associated with the device; and
output, to a particular network-accessible resource, an access request, wherein outputting the access request includes outputting the security score and the one or more digital signatures generated by the particular wireless network, wherein the network-accessible resource accepts or denies the access request based on the security score and the one or more digital signatures generated by the particular wireless network.

9. The non-transitory computer-readable medium of claim 8, wherein the security device includes a Europay, Mastercard, Visa (“EMV”) chip.

10. The non-transitory computer-readable medium of claim 8, wherein wirelessly communicating with the security device includes communicating with the security device using a Near Field Communication (“NFC”) protocol.

11. The non-transitory computer-readable medium of claim 8, wherein the network-based authentication information includes an indication that the wireless network has verified an identifier of the device.

12. The non-transitory computer-readable medium of claim 11, wherein the identifier includes at least one of:
a Mobile Directory Number (“MDN”),
an International Mobile Station Equipment Identity (“IMEI”), or
an International Mobile Subscriber Identity (“IMSI”).

13. The non-transitory computer-readable medium of claim 8, wherein the plurality of processor-executable instructions further include processor-executable instructions to:
monitor or receive network-based authentication information associated with the device over time; and
modify the security score for the device on an ongoing basis based on the network-based authentication information received or monitored over time.

14. The non-transitory computer-readable medium of claim 8, wherein the security device is a first security device, wherein the plurality of processor-executable instructions further include processor-executable instructions to:
wirelessly communicate with a second security device; and
modify the security score for the device further based on wirelessly communicating with the second security device.

15. A method, comprising:
wirelessly communicating, by a device, with a security device;
maintaining information indicating that the device has wirelessly communicated with the security device;
receiving network-based authentication information associated with the device, wherein the network-based authentication information includes one or more digital signatures generated by a particular wireless network;
generating a security score for the device based on:
the information indicating that the device has wirelessly communicated with the security device, and
the network-based authentication information associated with the device; and
outputting, to a particular network-accessible resource, an access request, wherein outputting the access request includes outputting the security score and the one or more digital signatures generated by the particular wireless network, wherein the network-accessible resource accepts or denies the access request based on the security score and the one or more digital signatures generated by the particular wireless network.

16. The method of claim 15, wherein the security device includes a Europay, Mastercard, Visa (“EMV”) chip.

17. The method of claim 15, wherein wirelessly communicating with the security device includes communicating with the security device using a Near Field Communication (“NFC”) protocol.

18. The method of claim 15, wherein the network-based authentication information includes an indication that the wireless network has verified an identifier of the device, wherein the identifier includes at least one of:
a Mobile Directory Number (“MDN”),
an International Mobile Station Equipment Identity (“IMEI”), or
an International Mobile Subscriber Identity (“IMSI”).

19. The method of claim 15, further comprising:
monitoring or receiving network-based authentication information associated with the device over time; and
modifying the security score for the device on an ongoing basis based on the network-based authentication information received or monitored over time.

20. The method of claim 15, wherein the security device is a first security device, the method further comprising:
wirelessly communicating with a second security device; and
modifying the security score for the device further based on wirelessly communicating with the second security device.
